(19) United States
(12) Patent Application Publication
(10) Pub. No.: US 2009/0125392 A1
(43) Pub. Date: May 14, 2009

(54) Method of displaying auction listing information on auction calendar using asynchronous Web service

(76) Inventors: Paul Shiu-Chang Chay, Tampa, FL (US); Jia Wang, Tampa, FL (US)

Correspondence Address: Paul Chay, 501 Lantern Circle, Tampa, FL, 33617, US

(21) Appl. No.: 11/983,819

(22) Filed: Nov. 14, 2007

(51) Int. Cl. G06Q 30/00

(52) U.S. Cl. 705/14; 705/27

(57) ABSTRACT

A method was designed to facilitate the advertisement of land auction listings for an online audience. The method includes displaying auction listing information on the Auction Calendar using Asynchronous Web Service. Wherein the advertised auction events are displayed according to the advertisement period on the graphically presented calendar. An Asynchronous Web Service is implemented to organize a user-orientated interface to automatically provide a list of auction events from the server without interrupting the user's actions. The listing is displayed as the user places the cursor over the dates in the calendar. The method allows the user to update the date and view the auction listings for a chosen date in real-time, to filter and manipulate the auction event data without refreshing the page.

### BACKGROUND OF THE INVENTION

Land auction online advertisements are commonly found to be in the form of a list of auctions. The listing usually provides a brief description of the auction and a link to the auction detail pages.

Some examples of websites containing this kind of auction calendar are Auctioneers.org, Eaglestar.net, LandandFarm.com, Farmersnational.com, Woltz.com, Midwestmessenger.com, LandFlip.com, alliancelandauction.com, eauctionexchange.com, etc.

Auctioneers.org offers a search option for users to find an auction listing; the options include keywords, auction date, city, state, country, location radius, auction category, and Auction Company. The result of the search is a Google map showing the location of the auction with a link to the auction details. The details of the auction provide the following information: company, number/title, address, city/state, time/date and brief description. The links provided for each listing are: Show on Map, View Auction and View Image Gallery. Auctioneers.org has the largest amount of land auctions we have seen.

Eaglestar.net offers a land auction calendar in the form of listings which can be sorted by auction date and price. The listings information is specified by the customer, and it shows the date the listing was added to the website; an image of the listing can be added if desired. A link is provided for the users to go to the auctioneer's website.

LandandFarm.com organizes their auction listings by date, starting with the most recent. The information provided includes contact information, titled linked to the land details page, land use, land area, country, state, and county.

Having the auction listings presented in this format is not very user friendly; users cannot obtain the necessary information in the least amount of time.

To overcome this drawback, a different type of auction calendar was introduced, incorporating the graphical display of an actual calendar.

Some examples of websites containing this kind of auction calendar are: LandAuction.com and caauctioneers.org, LandAuction.com offers a JavaScript powered calendar. The main function of this calendar is that it displays the date in which a single auction event is held. The dates are highlighted with different colors that represent the different states. Placing the cursor over a highlighted date activates a JavaScript window with a link to the details of the listings. The auction listings being promoted on this calendar are only the listings being offered by LandAuctions.com. One of the drawbacks of this calendar is that the window providing the link to the listing is too big for such small amount of information. Also, the color coding used is not very efficient because if two events are held on the same date, it is unclear what color would be used.

Caauctioneers.org provides auction events information in the form of a graphically represented calendar and a list, which appear simultaneously on the webpage. By default, all the auction events are shown in a list form and the calendar is set to the current month. The calendar displays the date of upcoming auction events with a different color, linked to a list of the events for that date. The list of events displays the following information for each auction: city, state, company, date and time of event, an image, and a brief description; it also provides a link to auction details page. Furthermore, the users are allowed to place links to an online bidding sites and virtual tours. There are several programming errors associated with the calendar, one of which is the presence of highlighted and linked dates that contain no events being held on that date. One of the drawbacks this calendar contains is that when searching for auction events in future months, and after viewing listings for a selected date, the auction calendar is reset to the current month again.

### BRIEF SUMMARY OF THE INVENTION

The Auction Calendar applying the claimed method was designed for land auction advertisement purposes for an online audience. The novelty of the claimed method is that the auction events are shown in a window using the asynchronous web development method, not for a specific auction date, but for an advertisement period specified by the user. The Auction Calendar also shows multiple auction events from multiple auction companies. The listings being advertised on the calendar are sorted in alphabetical order by state, and each state is further arranged by auction date. The Calendar displays basic information about each listing, which is linked to the listing land details page. The users of the invented

Auction Calendar are able to view the auction listings being advertised by placing the cursor on the calendar, and if the user desires, the user is able to filter the auction calendar by state.

### BRIEF DESCRIPTION OF THE DRAWINGS

FIGS. 1A-1C illustrate the navigation of the Auction Calendar based on (A) the advertising period, (B) the auction date, and (C) the bidding period.

FIG. 2 displays the procedure to place the advertisement on the Auction Calendar.

FIG. 3 shows the graphic presentation of the message flow from the Client System to the server system and back using asynchronous web development method.

### DETAILED DESCRIPTION

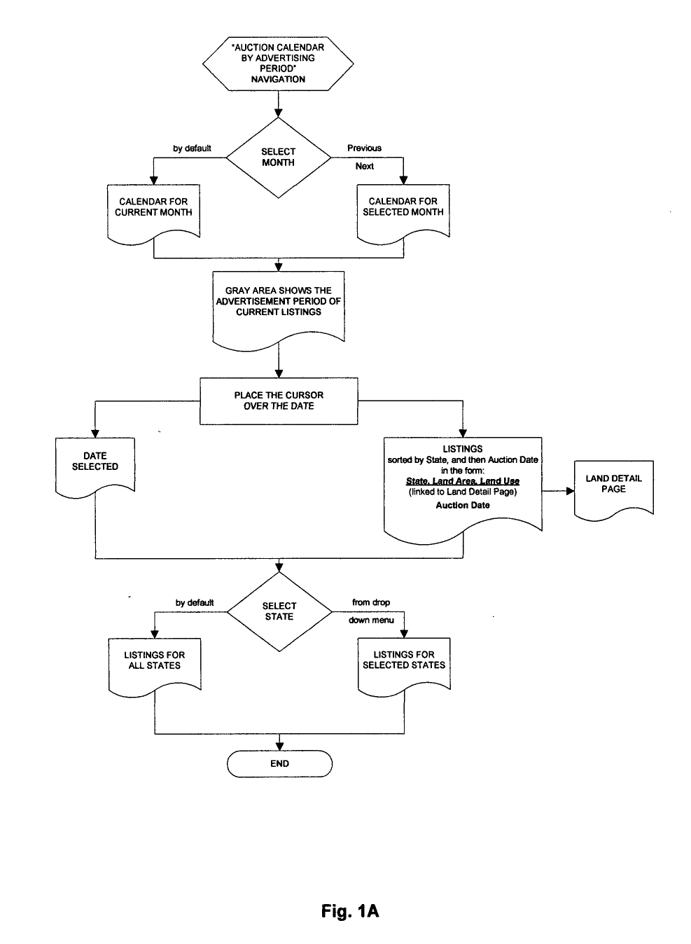

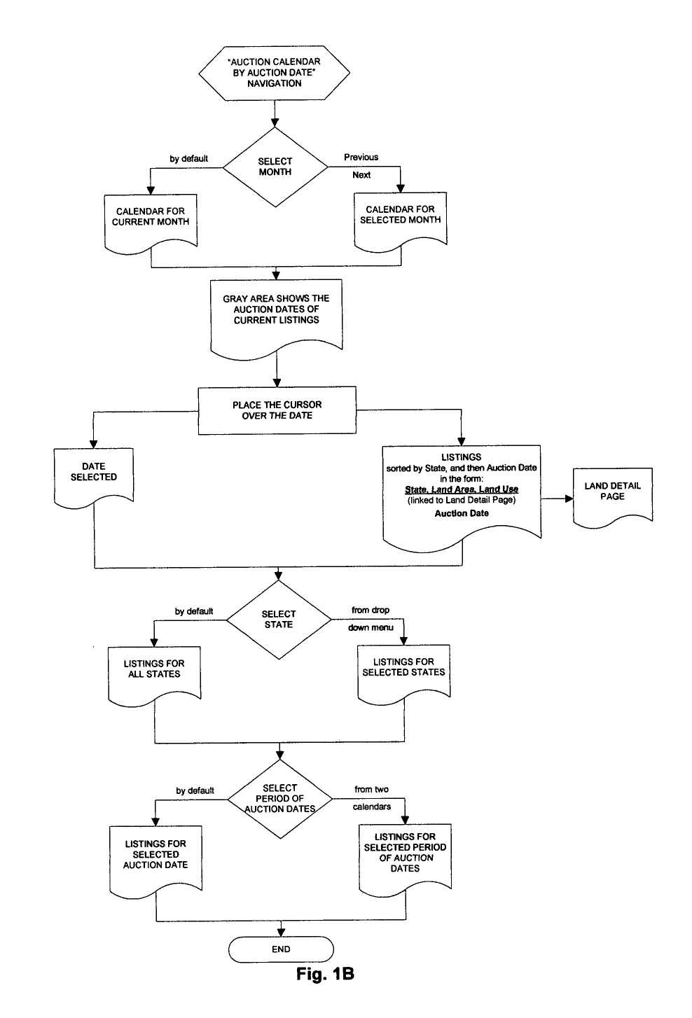

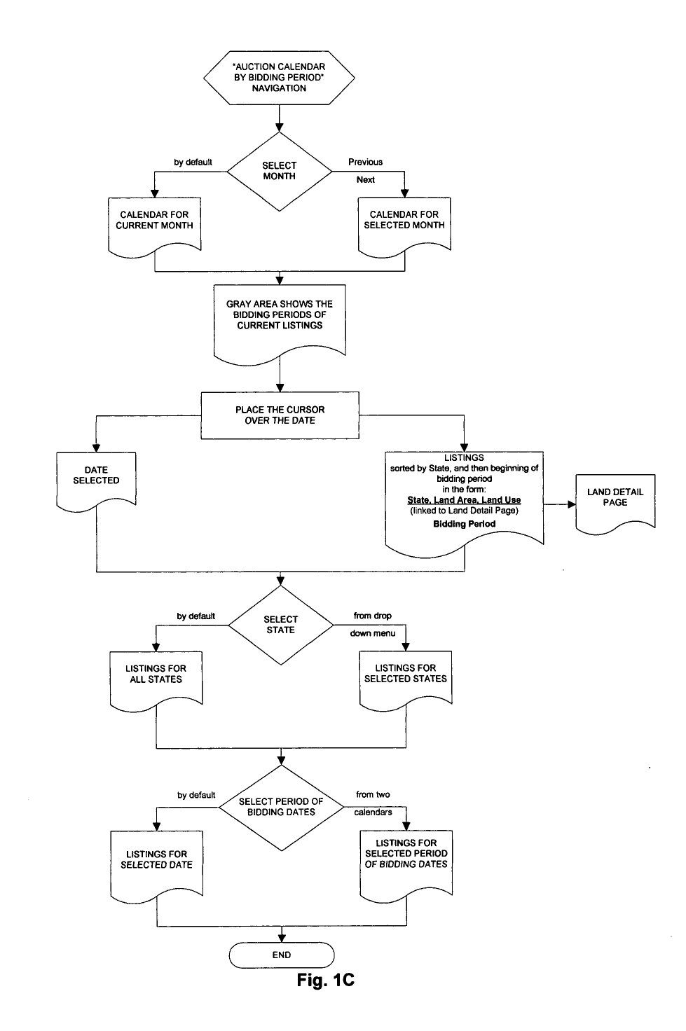

The present invention provides a method of advertising auction listings that allows users to gather the greatest amount of information, in the shortest amount of time. The fact that the Auction Calendar displays multiple auction events from multiple auction companies reduces the need of the users to go to different locations to find the information needed. When a user wants to find auction listings on the Auction Calendar, the user only needs to go to the section of the website containing the Calendar. Currently, three types of action calendar have been developed: 1) auction calendar based on the advertising period, 2) auction calendar based on the auction date, and 3) auction calendar based on the bidding period. The former type of calendar serves a purpose of the auction listings advertisement and is usually displayed as a default calendar. The later two calendars have been created in parallel to accommodate the needs of the user who wishes to view the auction listings arranged by auction date and bidding period, respectively. The block diagrams for navigation process of three types of calendar are depicted in FIG. 1A, FIG. 1B, and FIG. 1C.

FIG. 1A illustrates the detailed navigation of the Auction Calendar based on advertising period. By default, the Auction Calendar displays a calendar for the current month containing auction listings. The user is also able to navigate the Calendar and select previous or subsequent months. The gray area in the Calendar shows the auction listings being advertised for the month selected. By placing the cursor over the dates of the month that are marked with a gray background, the user is able to view a complete list of the auction listings being advertised during the selected date. The auction listings being advertised on the invented Auction Calendar are sorted in alphabetical order by state. Furthermore, the states that have auction listings being advertised during the date selected are additionally sorted by the auction dates in an ascending order. The auction listings being advertised are displayed on the Calendar in the form of: State. Land Area, Land Use and Auction Date. The underlined information of each of the auction listings presented on the invented Calendar is linked to the land details page of the listing, where the user is able to find the following information about the auction listing: address, city, county, state, zip code, land use, land area, price and a description of the listing; furthermore, the land details page of the auction listing contains the contact information of the person or company that placed the advertisement. The information provided on the land details page of each of the auction listings, is entered by the person running the advertisement of the listing. By default, the Calendar displays a list of all of the states that have auction listings being advertised during the current month or the month selected by the user. The users of the Auction Calendar are able to filter the list of the advertised auction listings displayed by the Calendar by selecting a specific state from a drop down menu. After a state is selected from the drop down menu, the Auction Calendar will display a list, for the selected state, of auction listings being advertised for the current month or the month selected by the user. The list of the auction listings being advertised for a specific state is sorted using the auction dates in an ascending order.

FIG. 1B displays the pictoral model of the navigation process for the Auction Calendar based on the auction date. The navigation algorithm is analogous to the Auction Calendar based on advertising period. In this case, the gray area shows the auction dates for the current auction events. Although not explicitly shown, the displayed listings are controlled by the advertising period, which acts as an activation switch for the listing to appear on the calendar. Besides the ability for the user to filter the auction listings by the state, there is an option of filtering by the period of auction dates. This feature allows the user to acquire the list of auction events for a desired time interval of auction dates: a month, a week, or a single day.

FIG. 1C presents the block diagram of the navigation process for the Auction Calendar based on the bidding period. Similar to the previous type of calendar, the navigation algorithm is analogous to the Auction Calendar based on advertising period. The major difference lies in the calendar display: the gray area shows the bidding periods for the auction events during their advertising period. Also, the form of the auction listings display is modified to include the Bidding Period instead of Auction Date. In addition, there is an option for a user to select the period of bidding dates using the asynchronous web service and filter the auction listings according to the desired period of bidding dates.

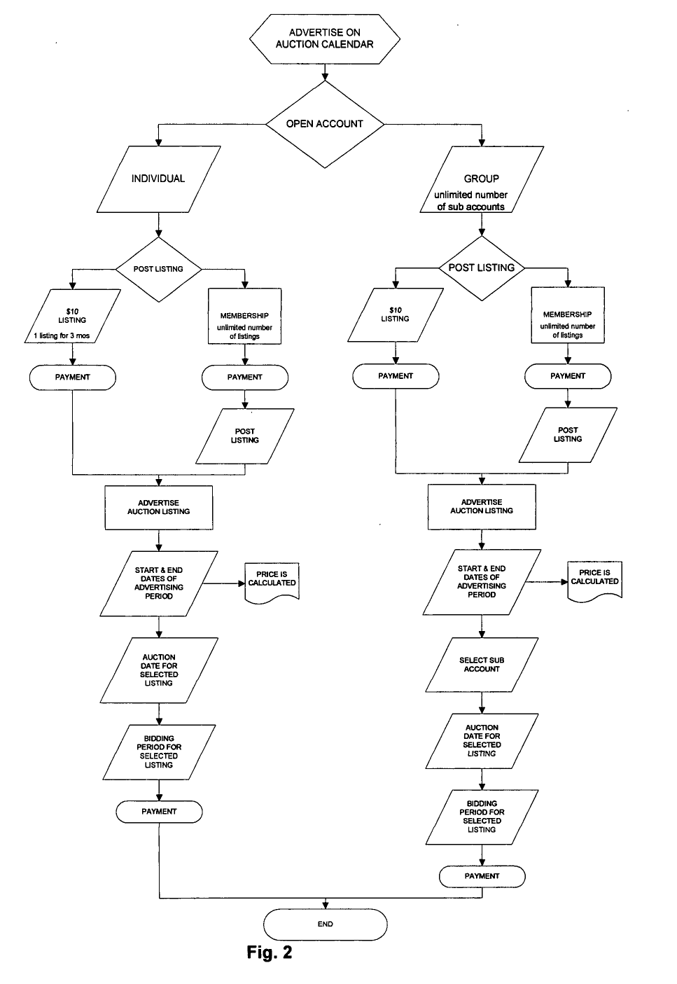

FIG. 2 illustrates the detailed procedures a user will need to follow to place an advertisement on the Auction Calendar. The user will first have to open a free account with the website LandBlueBook.com. When opening an account the user is given the option of opening an individual account or a group account, depending on the user's needs. An individual account is generally used by owners and by independent brokers. A group account is generally used by Companies that have more than one agent; by opening a group account, the user is able to input an unlimited number of sub-accounts, therefore being able to include all of the company's agents. After the user has opened a free account, the user is able to post listings on the database of LandBlueBook.com. When the user desires to input an auction listing on the LandBlueBook.com database, the user is provided with two options: $10 Listing or Membership. The $10 Listing option allows the user to input one auction listing on the database; the auction listing remains on the LandBlueBook.com database for a period of three months. When choosing to post an auction listing on the database using the $10 Listing option, the user is prompted to first input the listing information and then to make the 10.00 USD payment. Membership allows the user to input an unlimited number of listings on the LandBlueBook.com database. When opting to post auction listings on the database by becoming a member, the user is asked to pay the one year membership fee before the user is able to post auction listings on the LandBlueBook.com database. After the user has made the membership payment, the user is then able to post an unlimited number of auction listings on the LandBlueBook.com database. If the user has opened a group account, and paid for a group membership, the user must enter at least one agent into the group account before the user is able to post auction listings on the LandBlueBook.com database. After the user has posted an auction listing on the LandBlueBook.com database, the user will have the option of advertising the auction listing on the Auction Calendar. When the user selects to advertise an auction listing on the Calendar, the user will be prompted to input a start and an end date for the period of time the auction listing will be advertised on the created Auction Calendar. When an advertisement period is selected, the price will be calculated and presented to the user. If the user has an individual account, from a list containing all of the auction listings the user has placed on the LandBlueBook.com database the user will be prompted to select the auction listing to be advertised and input its auction date and bidding period. If the user has a group account, the user will be asked to select one of the agents, from a list of agents, the user has entered into the account as sub-accounts. After selecting the sub-account that contains the auction listing the user wishes to advertise on the created Calendar, from a list containing all of the auction listings the sub-account has placed on the LandBlueBook.com database the user will be prompted to select the auction listing to be advertised and input its auction date and bidding period. After selecting the auction listing to be advertised on the created Calendar, the user will be asked to make the payment for the period of time the auction listing advertisement will be displayed on the auction calendar.

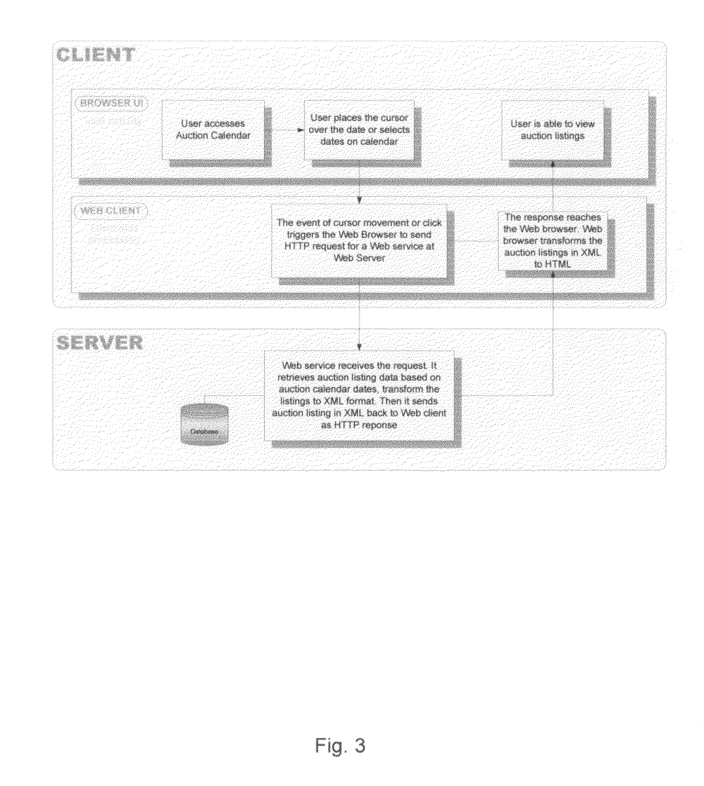

FIG. 3 is the graphic representation of the message flow from the client system to the server system of the method described above. The client system and server system here are the Internet browser and web server, respectively. Initially, a user accesses the auction calendar. After that, the user moves the cursor or clicks on the dates on the auction calendar. This user's action will trigger an HTML request message sent to the server system via the browser. This message contains, for example, the dates that the user selected. Once the Web server receives the request, it retrieves the relevant auction listing data from the database where the listing information is stored and transforms the data to the XML format. Then, the Web server sends the auction listing data in the XML to the Internet browser as a corresponding HTML response. The browser then transforms the data to the HTML format and presents it to the user. At this moment, the user has all the listings information.

The presented above detailed description provides the explanation of the mechanism the invention is based on. The constituencies of the invention's mechanism, as well as the objective orientation can be modified to expand the market of its users. As an example, the invention can be applied to the different layers of market expanding its application to residential and commercial real estate and other categories of auction. A further expansion of the invention's market holds its potential in the International direction besides the U.S.A. Moreover, the presentation of the invention is not limited to the embodiments illustrated in the detailed description. Being the user-centric application, the invention's embodiment can be modified to include the video, slide, and other up-to-date graphical presentation techniques in order to appear the most appealing for the user.

We claim:

1. A method of accessing and displaying an auction listing information using Asynchronous Web Service comprising:
generating messages flowing from a client system to a server system upon user's request on-line, wherein client system and server system comprising an Internet browser and a web server respectively, wherein the web server comprising a database having a plurality of relevant auction listings information stored therein;
displaying an auction calendar having plurality of dates;
selecting at least a date on the auction calendar to trigger an HTML request message sent to the server system via the browser;
retrieving the relevant auction listing information from the database and presenting the listing information to a XML format;
transmitting the auction listing data in XML format to the Internet browser via the Web server, as a corresponding HTML response;
transforming the data to the HTML format and displaying auction listing information to the user via the browser.

2. The method of claim 1 wherein the selecting of calendar date on the auction calendar comprising at least one of the following: moving a cursor, clicking a date, touching the screen, and/or entering date by keyboard.

3. The method of claim 1 wherein the displaying of auction listing information comprising displaying of essential listing information linked to a listing land details page.

4. The method of claim 1 wherein the displaying of auction calendar including displaying at least one advertising period.

5. The method of claim 4 wherein the displaying of auction calendar further including displaying at least one auction date.

6. The method of claim 5 wherein the displaying of auction calendar including further displaying at least one bidding period.

7. The method of claim 6 wherein the displaying of auction listing information further including filtering information by state.

8. The method of claim 6 wherein the displaying of auction listing information further comprising sorting information in alphabetical order by state, and further sorted by auction dates in an ascending order.

9. The method of claim 6 wherein the at least one advertising period serves as an activating switch for the auction listing information to appear on the auction calendar.

10. The method of claim 4 wherein the displaying of each auction listing information during the advertising period comprising information applicable to at least one of a land auction, a residential and commercial real estate auction, and any other categories of auction.

11. The method of claim 6 wherein displaying listing information during the advertising period comprising displaying auction listing information in the form of at least one of slides, videos and other presentation techniques.
